(19) United States
(12) Patent Application Publication
(10) Pub. No.: US 2026/0109626 A1
(43) Pub. Date: Apr. 23, 2026

(54) ADVANCED ROTATIONAL HYDRODYNAMIC CAVITATION SYSTEM FOR THE IRREVERSIBLE DESTRUCTION OF C-F BONDS IN FOREVER CHEMICALS

(71) Applicant: 8215 Technology Inc, St. George, UT (US)

(72) Inventors: Jamie Cox, St. George, UT (US); Tane Remington, Livermore, CA (US)

(73) Assignee: 8215 Technology Inc, St. George, UT (US)

(21) Appl. No.: 19/366,300

(22) Filed: Oct. 22, 2025

Related U.S. Application Data
(60) Provisional application No. 63/710,705, filed on Oct. 23, 2024.

(51) Int. Cl. C02F 1/34; C02F 1/68; C02F 101/36

(52) U.S. Cl. CPC C02F 1/34; C02F 1/68; C02F 2101/36; C02F 2201/004

(57) ABSTRACT

A hydrodynamic cavitation system features a housing having a fluid inlet, a fluid outlet, a plurality of dimples on a front inner surface, and a plurality of dimples on a rear inner surface; a rotor having a plurality of dimples on a front face and a plurality of dimples on a rear face and positioned so that the plurality of dimples on the front face overlap with the plurality of dimples on the front inner surface of the housing, and the plurality of dimples on the rear face overlap with the plurality of dimples on the rear inner surface of the housing; as the rotor rotates, a plurality of first cavitation sites are formed via the partially overlapping dimples of the front face and the front inner surface, and a plurality of second cavitation sites are formed via the partially overlapping dimples of the rear face and rear inner surface.

### CROSS-REFERENCE TO RELATED APPLICATIONS

This application claims the benefit of U.S. Provisional Application Ser. No. 63/710,705, filed on Oct. 23, 2024, which is incorporated herein by reference.

### TECHNICAL FIELD

The present disclosure relates to hydrodynamic cavitation systems. More particularly, the present disclosure relates to an advanced hydrodynamic cavitation system for the irreversible destruction of chemical bonds.

### BACKGROUND

PFAS (perfluoroalkyl and polyfluoroalkyl substances), which resist grease, oil, water, and heat, are referred to as “forever chemicals. ” They are synthetic compounds (not found naturally in the environment), have existed for over 80 years, and are used in hundreds of products (e.g., cookware, carpets, clothing, fabrics, paper packaging for food, etc.). PFAS are emerging contaminants because of the risk they pose to human health and the environment are not well understood. Preliminary laboratory tests suggest that PFAS poses adverse health effects on animals and humans. PFAS do not readily break down when exposed to air, water, or sunlight. PFAS are made up of at least one fully fluorinated methyl or methylene carbon atom (with a few exceptions). What makes PFAS molecules so difficult to degrade is this carbon and fluorine (C—F) bond, since it is one of the strongest that exists in chemicals. The EPA states that there are about 14,735 distinct PFAS chemical compounds, while PubChem lists 6 million. However, current federal mandates are to analyze and remediate only 40 specific PFAS chemicals in water.

Currently, the most mature and commonly adopted technique to remove PFAS is granulated activated carbon (GAC). This is not a novel technique and has primarily been used to filter water for safe drinking. However, adopting this method for PFAS removal poses many disadvantages: 1) the amount of GAC required to successfully remove PFAS is prohibitive; 2) GAC is disposed as hazardous waste; 3) GAC is not well suited to remove short-chain PFAS; and, 4) due to the limited lifetime of GAC, this technique results in high continuous costs for the wastewater treatment facilities. As a result, there is currently no economical, sustainable, and scalable solution to remove PFAS from water.

Accordingly, there is a need for a system that is capable of removing PFAS and/or other forever chemicals, among other substances, from water or other liquids. The present disclosure seeks to solve these and other problems.

### SUMMARY OF EXAMPLE EMBODIMENTS

In some embodiments, a hydrodynamic cavitation system comprises a housing having dimples on a front inside surface and a rear inside surface, a single rotor with a plurality of dimples (e.g., ten or more) on a front face and a plurality of dimples on a rear face, a drive shaft, a variable speed motor, and a pump. The gap distance between the rotor and front inside surface and rear inside surface of the housing ranges from 0.1 mm-100.0 cm.

In some embodiments, an acidic radical, such as, but not limited to, sodium persulfate, may be added to the system to synergistically help the cavitation process irreversibly break PFAS chemicals in water or other liquids.

In some embodiments, the dimple geometries can be cone, cylinder, or sphere in shape. The dimple sizes and depths can range from 1.0-50.0 mm. In some embodiments, the rotor comprises multiple rows of dimples.

In some embodiments, the rotor diameter ranges from 3.0-55.0 cm and can be a variety of shapes, from cylindrical to conical, and can be symmetric or asymmetric. The rotor speed may range from 500-10,000 RPM, and is driven with indirect or direct drive from a motor with HP ranging from 10-100 HP.

In some embodiments, cavitation can also be created by blades (similar to hydrofoil blades). The blades may be on the perimeter of the rotor or on any of the rotor's surface area, to maximize the cavitation cloud.

### BRIEF DESCRIPTION OF THE DRAWINGS

FIG. 1 illustrates a front elevation view of a rotor with a single row of dimples of a hydrodynamic cavitation system;

FIG. 2A illustrates a front elevation view of a rotor with multiple rows of dimples of a hydrodynamic cavitation system;

FIG. 2B illustrates a partial front perspective view of a rotor taken along the circle 2B of FIG. 2A of a hydrodynamic cavitation system;

FIG. 3 illustrates a front elevation view of a rotor with blades of a hydrodynamic cavitation system;

FIG. 4 illustrates a front, side perspective view of a cone shaped rotor with blades of a hydrodynamic cavitation system;

FIG. 5 illustrates a front, side perspective view of a hydrodynamic cavitation system;

FIG. 6 illustrates a front, side perspective cross-section of a hydrodynamic cavitation system;

FIG. 7 illustrates a front, side perspective exploded view of a hydrodynamic cavitation system;

FIG. 8 illustrates a rear, side perspective exploded view of a hydrodynamic cavitation system;

FIG. 9 illustrates a front, side perspective view of a hydrodynamic cavitation system;

FIG. 10 illustrates a rear perspective view of a hydrodynamic cavitation system;

FIG. 11 illustrates a cross-sectional side elevation view of a hydrodynamic cavitation system;

FIG. 12 illustrates a cross-sectional front, side perspective view of a hydrodynamic cavitation system;

FIG. 13 illustrates a front, partially exploded view of a hydrodynamic cavitation system; and

FIG. 14 illustrates a front, side perspective view of a rotor of a hydrodynamic cavitation system.

### DETAILED DESCRIPTION OF EXAMPLE EMBODIMENTS

The following descriptions depict only example embodiments and are not to be considered limiting in scope. Any reference herein to “the invention” is not intended to restrict or limit the invention to exact features or steps of any one or more of the exemplary embodiments disclosed in the present specification. References to “one embodiment,” “an embodiment,” “various embodiments,” and the like, may indicate that the embodiment(s) so described may include a particular feature, structure, or characteristic, but not every embodiment necessarily includes the particular feature, structure, or characteristic. Further, repeated use of the phrase “in one embodiment,” or “in an embodiment,” do not necessarily refer to the same embodiment, although they may.

Reference to the drawings is done throughout the disclosure using various numbers. The numbers used are for the convenience of the drafter only and the absence of numbers in an apparent sequence should not be considered limiting and does not imply that additional parts of that particular embodiment exist. Numbering patterns from one embodiment to the other need not imply that each embodiment has similar parts, although it may.

Accordingly, the particular arrangements disclosed are meant to be illustrative only and not limiting as to the scope of the invention, which is to be given the full breadth of the appended claims and any and all equivalents thereof. Although specific terms are employed herein, they are used in a generic and descriptive sense only and not for purposes of limitation.

Unless otherwise expressly defined herein, such terms are intended to be given their broad, ordinary, and customary meaning not inconsistent with that applicable in the relevant industry and without restriction to any specific embodiment hereinafter described. As used herein, the article “a” is intended to include one or more items. When used herein to join a list of items, the term “or” denotes at least one of the items, but does not exclude a plurality of items of the list. For exemplary methods or processes, the sequence and/or arrangement of steps described herein are illustrative and not restrictive.

It should be understood that the steps of any such processes or methods are not limited to being carried out in any particular sequence, arrangement, or with any particular graphics or interface. Indeed, the steps of the disclosed processes or methods generally may be carried out in various sequences and arrangements while still falling within the scope of the present invention.

The term “coupled” may mean that two or more elements are in direct physical contact. However, “coupled” may also mean that two or more elements are not in direct contact with each other, but yet still cooperate or interact with each other.

The terms “comprising,” “including,” “having,” and the like, as used with respect to embodiments, are synonymous, and are generally intended as “open” terms (e.g., the term “including” should be interpreted as “including, but not limited to,” the term “having” should be interpreted as “having at least,” the term “includes” should be interpreted as “includes, but is not limited to,”etc.).

As previously discussed, there is a need for a system that is capable of removing PFAS and/or other forever chemicals, among other substances, from water or other liquids. The hydrodynamic cavitation system disclosed herein solves these and other problems.

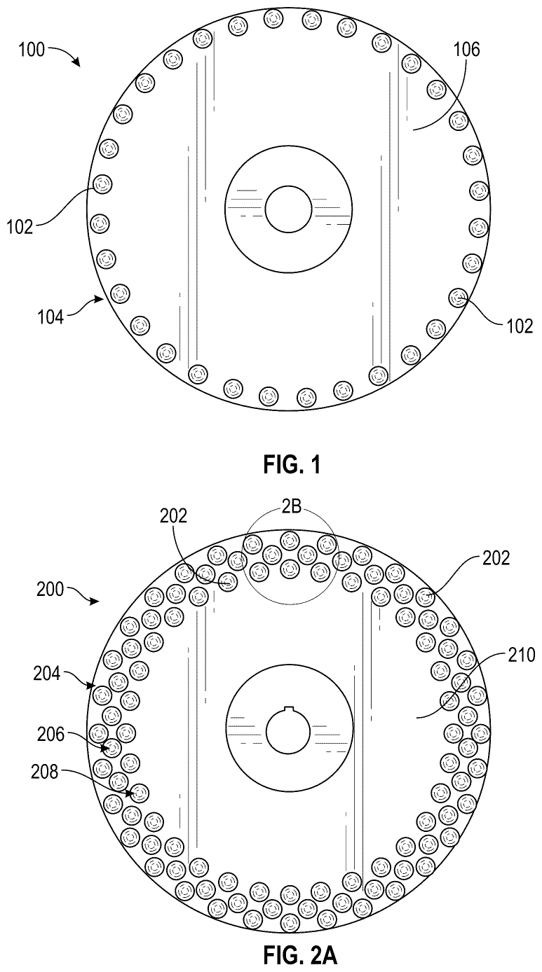

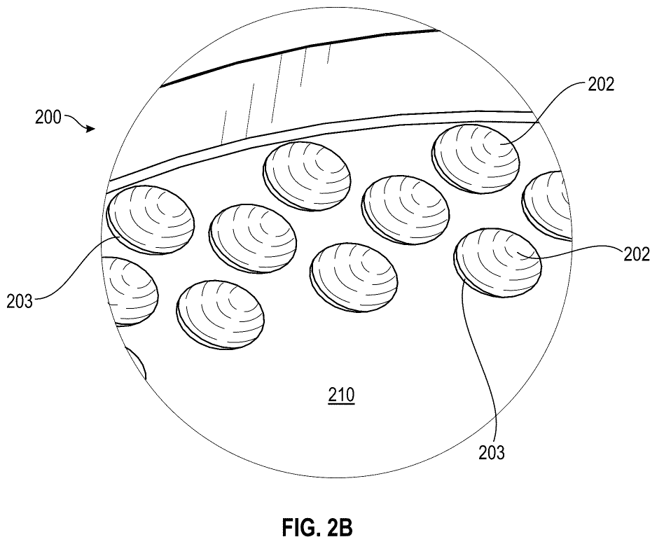

In some embodiments, as shown in FIG. 1, a rotor 100 comprises a plurality of dimples 102 in a single row 104 around a first surface 106. While referred to as “dimples” the surface architecture or geometry can be cone, cylinder, sphere, or any other recessed shape. Additionally, the dimples 102 may be configured near the outer edge of the rotor 100, as shown, but may also be located at other positions on the first surface 106. The sizes and depths of the dimples 102 can range from 1.0-50.0 mm. Further, each dimple 102 has at least one edge (best seen in FIG. 2B and described later herein) having an attack angle between 0-89 degrees, resulting in supercavitation when the system is operated, as will be discussed in more detail herein. Importantly, the attack angles of the edge of the dimples 102 create a gap of liquid between the rotor 100 and stator and the supercavitating flow, protecting the metal the rotor 100 and stator, among other components, from any cavitation damage. Supercavitation not only kills bacteria, pathogens, and viruses, but it can break chemical bonds, including PFAS, to thereby remove unwanted forever chemicals from water. The edge can be machined, cast, or otherwise formed on the outer rim of each dimple 102.

In some embodiments, an acidic radical, such as, but not limited to, sodium persulfate, potassium persulfate, and/or peracetic acid, may be added to the system to synergistically help the cavitation process irreversibly break PFAS chemicals in water or other liquids. The addition of the acidic radical does not create secondary pollution as a byproduct. In other words, sodium persulfate produces SO⋅₄^{-¿¿} radicals which interact with the ⋅OH^{-¿¿} radicals produced in water during cavitation and create a synergistic effect, enhancing the defluorination process. Utilizing the hydrodynamic cavitation system disclosed herein with the acidic radical irreversibly degrades the C—F bonds in PFAS. The addition of an acidic radical, such as sodium persulfate, is highly favorable due to its stability, solubility, and non-secondary pollution. As a result, the hydrodynamic cavitation system and method of use disclosed herein overcomes the limitations in the prior art.

Referring to FIGS. 2A-2B, in some embodiments, the rotor 200 comprises a plurality of dimples 202 positioned in a plurality of rows 204, 206, 208 on a first surface 210. The rows 204, 206, 208 may be configured as concentric circles, and may be positioned to partially overlap, as shown, but may also be non-overlapping rows. Like the embodiment of FIG. 1, the sizes and depths of the dimples 202 can range from 1.0-50.0 mm and the geometry of the dimples 202 can be cone, cylinder, or sphere in shape. Further, each dimple 202 has an edge 203 with an attack angle between 0-89 degrees, resulting in supercavitation. As described earlier, the edge 203 can be machined, cast, or otherwise formed on at least a portion of the outer rim of each dimple 102. In some embodiments, as shown, each edge 203 only occupies a portion of the outer rim of each dimple 202, facilitating supercavitation at the edge 203.

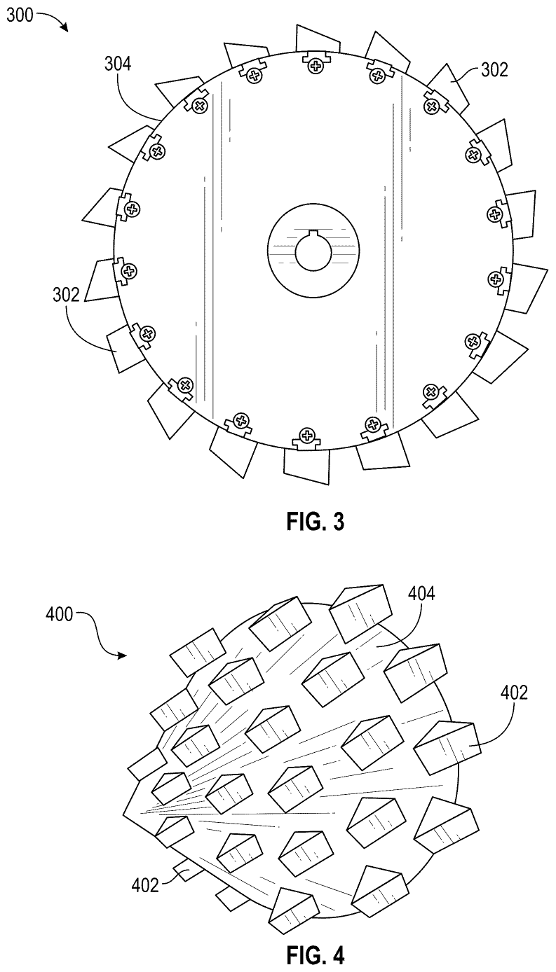

In some embodiments, cavitation can also be created by blades (similar to hydrofoil blades). For example, referring to FIG. 3, a rotor 300 comprises a plurality of blades 302 extending radially from the outer circumference 304 of the rotor 300. While the blades 302 are illustrated as extending radially, the blades 302 may be on the perimeter of the rotor 300 or on any of the surface area of the rotor 300, which may be circular, cylindrical, conical, or in other shapes, to maximize a cavitation cloud. Like the dimples described earlier, the blades 302 preferably have edges with attack angles between 0-89 degrees. It will be understood that the rotor 300 may also comprise dimples, allowing both the blades 302 and dimples to create supercavitation.

Additionally, it will be appreciated that the rotor of the hydrodynamic cavitation system can be in a variety of shapes. For example, referring to FIG. 4, in some embodiments, the rotor 400 may be conical in shape (and may be other shapes, symmetrical, asymmetrical, etc.). As shown, the rotor 400 may comprise a plurality of blades 402 extending along the exterior conical surface area 404. It will be appreciated that the shapes, placement, angle, etc. of the blades 402 may vary from those shown without departing herefrom. Additionally, it will be appreciated that the rotor 400 may comprise just blades 402, a combination of blades 402 and dimples, or just dimples. The cone shape shown in FIG. 4 may help increase the efficiency of the system by eliminating dead zones in the liquid (which decreases drag) and increasing the cavitation cloud volume.

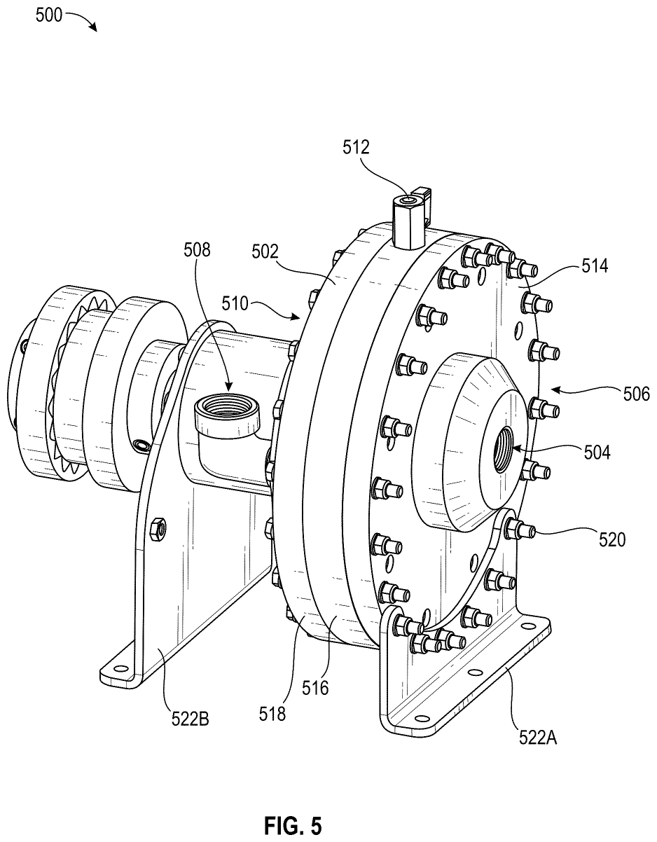

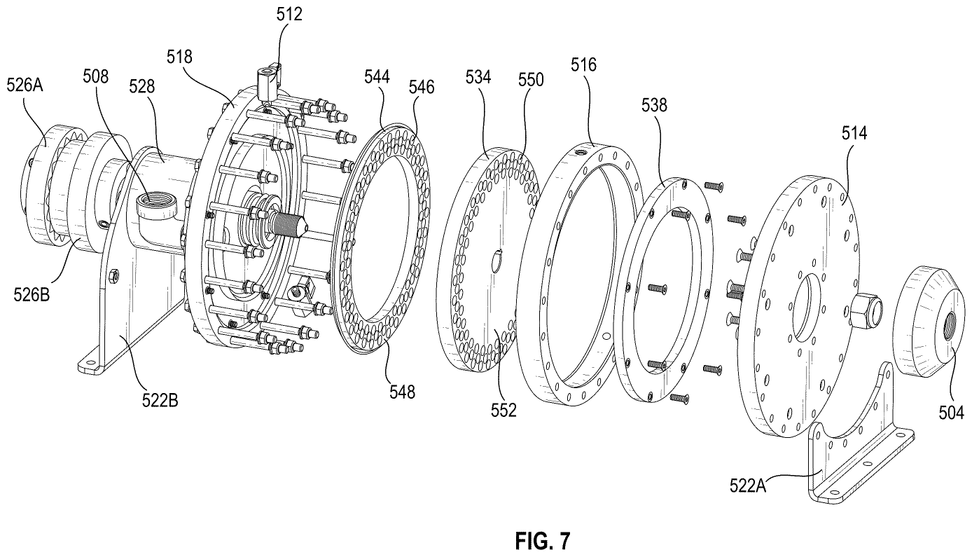

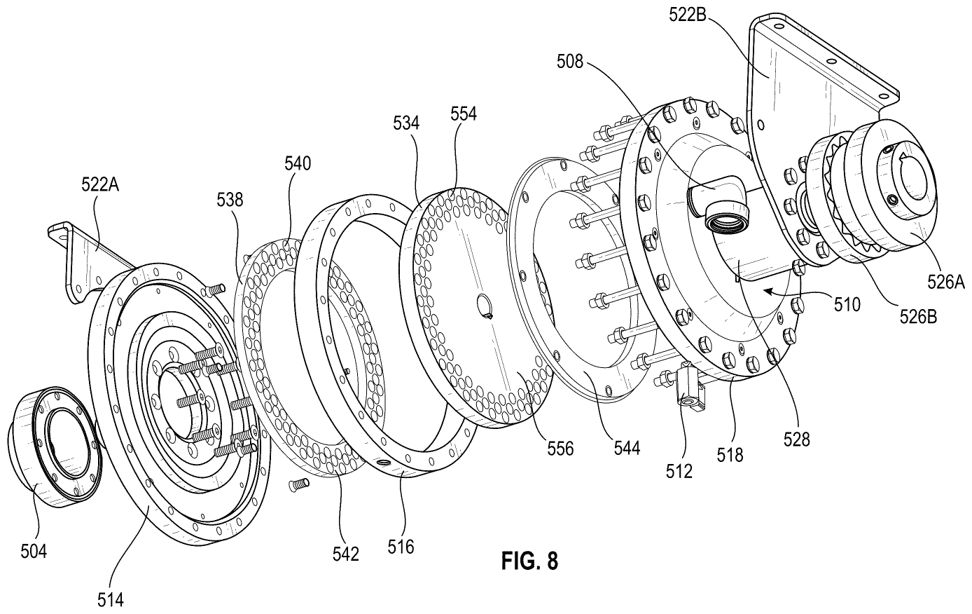

Referring now to FIGS. 5-8, a hydrodynamic cavitation system 500 may comprise a housing 502 having a fluid inlet 504 on a front side 506 of the housing 502 and a fluid outlet 508 on rear side 510 of the housing 502. Fluids such as wastewater, blackwater, greywater, etc. may be circulated via a pump (not shown) through the fluid inlet 504 for treatment within the housing 502 before being expelled via the fluid outlet 508. The housing 502 may comprise one or more pressure relief valves 512, though not required, configured to control or limit the pressure within the housing 502 and to provide an auxiliary passage for pressurized fluids to be diverted when built up in excess. The pressure relief valve 512 may be manually opened or otherwise configured to automatically open at a predetermined pressure to protect the hydrodynamic cavitation system 500 and related equipment from being subjected to pressures that exceed their design limits.

In some embodiments, the housing 502 is formed from an assembly of components. For example, the housing 502 may comprise a front cover 514, a center cover 516, and a rear cover 518. The respective covers 514, 516, 518 may be coupled together via bolts 520 or similar coupling mechanisms. One or more brackets 522A-B may support the housing 502 and a driveshaft 524.

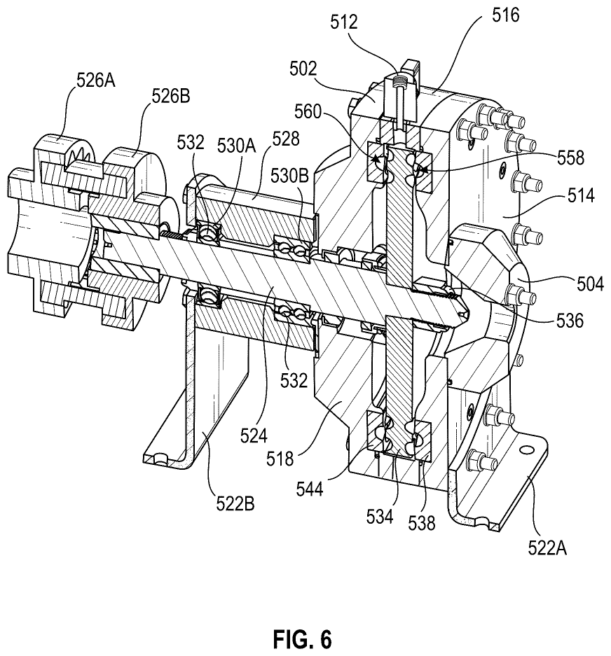

As best shown in FIGS. 6-8, in some embodiments, the hydrodynamic cavitation system 500 comprises a driveshaft 524 that enters through the rear cover 518 and protrudes beyond the front cover 514, where a front end is concealed within the inlet 504. The driveshaft 524 may be coupled to a variable speed motor, engine, or other power source. One or more shaft couplers 526A-B may be used to dampen vibration to the driveshaft 524. A bearing housing 528 may comprise one or more bearing assemblies 530A-B, which may each have a bearing preload ring that circumscribes the driveshaft 524 to add a sustained axial load, independent of external loads, to a plurality of ball bearings 532. In some embodiments, the bearing housing 528 may further comprise a breather vent, similar in function to the pressure release valves, and high visibility sights for dark liquid.

In some embodiments, the cavitation apparatus comprises a rotor 534 positioned and configured to rotate within the housing 502 (a stator in the system). The rotor 534 may be one of the embodiments discussed with regards to FIGS. 1-2. The driveshaft 524 pass through the rotor 534 is coupled thereto via a threaded nut 536. As shown, the driveshaft 524 may comprise a stepped outer circumference, effectively forming a clamp with the threaded nut 536, coupling the rotor 534 to the driveshaft 524. The front cover 514 may comprise a first dimple insert 538 comprising a plurality of dimples 540 on an inner surface 542, with each dimple comprising an edge with an attack angle between 0-89 degrees, as disclosed earlier herein. The rear cover 518 may comprise a second dimple insert 544 comprising a plurality of dimples 546 on its inner surface 548 with each dimple comprising an edge with an attack angle between 0-89 degrees.

The dimples 540 of the first dimple insert 538 are positioned to interact (e.g., at least partially overlap) a plurality of dimples 550 on a front face 552 of the rotor 534. The dimples 546 of the second dimple insert 544 are positioned to interact (at least partially overlap) with a plurality of dimples 554 on a rear face 556 of the rotor 534. As shown, the dimple inserts 538, 544 are configured so sit flush with the respective surfaces of the front and rear covers 514, 518.

While dimple inserts 538, 544 are discussed, it will be appreciated that, in some embodiments, the dimple inserts 538, 544 may be omitted and the front cover 514 may comprise the dimples (e.g., dimples 540) on its inner surface and the rear cover 518 may comprise the dimples (e.g., dimples 546) on its inner surface. The benefit of dimple inserts 538, 544 are that they are removably interchangeable. In other words, should any degradation occur to any edge having the attack angle, the dimple inserts 538, 544 may be removed and replaced using bolts or other fasteners. Additionally, if a user desires to utilize a different attack angle, they may quickly remove the dimple inserts 538, 544 and replace them with other dimple inserts having the desired attack angle on the edge of the respective dimples 540, 546. It will be appreciated that the front cover 514, rear cover 518, and dimple inserts 538, 544 all function as stators in the system 500.

As the plurality of dimples 540 on the first dimple insert 538 interact with (i.e., at least partially pass over) the plurality of dimples 550 on the front face 552 of the rotor 534, a plurality of first cavitation sites 558 are formed. Likewise, as the plurality of dimples 546 of the second dimple insert 544 interact (i.e., at least partially pass over) with the plurality of dimples 554 on the rear face 556 of the rotor, a plurality of second cavitation sites 560 are formed. As a non-limiting example, if the rotor 534 comprised three-rows of thirty-two dimples each on a front face 552 (as shown in FIG. 2A with rotor 200), a total of ninety-six first cavitation sites 558 are formed by interacting with the ninety-six dimples 540 on the first dimple insert 538. In other words, each dimple described herein corresponds to a respective cavitation site.

Each cavitation site 558, 560 is capable of generating extreme temperatures, reaching 4500° C. In other words, the implosion of bubble cavities at localized areas (e.g., each cavitation site 558, 560) yields turbulence (e.g., microjets), high temperature hotspots up to 4500° C., high pressures up to 1000 bar, oxidation, free radicals, shear forces, and shock waves. These disruptive and dynamic changes can be destructive to microorganisms in liquid, causing cells to lyse. By having ten or more cavitation sites (in other words, each pairing of dimples create a cavitation site, so the plurality of dimples 540, 550, 546, 554 on each respective surface create a plurality of cavitation sites), the hydrodynamic cavitation volume increases, increasing efficiency by increasing cavitation locations which can coalesce to become a macro cavitation site and cavitation cloud. In a preferred embodiment, there are at least ten cavitation sites. However, it will be appreciated that more, or fewer, than ten cavitation sites may be used without departing herefrom.

Cavitation occurs when the rotor 534 rotates within the housing 502. In other words, because the rotor 534 is coupled to the driveshaft 524, when the driveshaft 524 rotates, the rotor 534 likewise rotates, with the dimples 540, 550, 546, 554 then at least partially passing over one another, forming the cavitation sites 558, 560, respectively. In some embodiments, though without limitation, a speed of the rotor 534, as actuated by the driveshaft 524, ranges from 500-10,000 RPM, and is driven via indirect or direct drive from a variable speed motor with horsepower ranging from 10-100 HP.

Accordingly, liquid in need of treatment enters through the inlet 504. As the rotor 534 rotates, hydrodynamic cavitation occurs at the numerous cavitation sites 558, 560. It will be appreciated that a single cavitation site (i.e., a single pairing of overlapping dimples) emits temperatures close to 4500° C. The temperature required to break the bond energy of most schedule I-V drugs through thermal decomposition is 300-500° C., which is far below the temperature that is created by a single cavitation site. This extreme temperature removes bacteria, pathogens, viruses, as well as breaks chemical bonds, effectively treating water and other contaminated fluids. Testing has shown that more than 99% of PFAS are removed in a fraction of a second at varying flow rates (from 0.5 gallons per minute (GPM) to 100 GPM) via the hydrodynamic cavitation system 500 disclosed herein. As a result, the hydrodynamic cavitation system 500 very effectively disposes of nearly all organic and inorganic compounds, including harmful algal blooms, biomedical waste, and forever chemicals (e.g., perfluoroalkyl and polyfluoroalkyl substances) using the thermal decomposition, shear forces, and shock waves from the cavitation. The resultant liquid has been studied for several schedule II drugs. Research shows the remaining compounds are not toxic and, at worst, create gray water, which can be disposed of relatively easily. Therefore, fluids that pass through the hydrodynamic cavitation system 500 are thoroughly treated beyond the limitations of ultraviolet light and reverse osmosis techniques.

In some embodiments, additional solutions or substances may be added to the contaminated fluids before entering the hydrodynamic cavitation system 500 through the inlet 504. For example, hydrogen peroxide, ozone, and/or an acidic radical such as sodium persulfate, may be added to the liquid prior to cavitation. The means for mixing may comprise a continuous mixer, a centrifuge, a grinder, or similar known means of uniformly mixing the contaminated fluids before the ingoing flow rate is set. In some embodiments, the hydrodynamic cavitation system 500 comprises one or more pressure gauges coupled to the housing 502 which may be near the fluid inlet 504 to monitor the fluid pressure entering the housing 502. As the variable speed motor actuates the driveshaft 524, the rotor 534 spins, creating hydrodynamic cavitation at the plurality of cavitation sites 558, 560 thereby treating the entering contaminated water before being expelled through the fluid outlet 508. The plurality of dimples 540, 550, 546, 554 provide pressure fluctuations which lead to bubble implosions as part of the hydrodynamic cavitation process that breaks chemical bonds (including C—F bonds in PFAS) and eliminates bacteria, pathogens, and viruses.

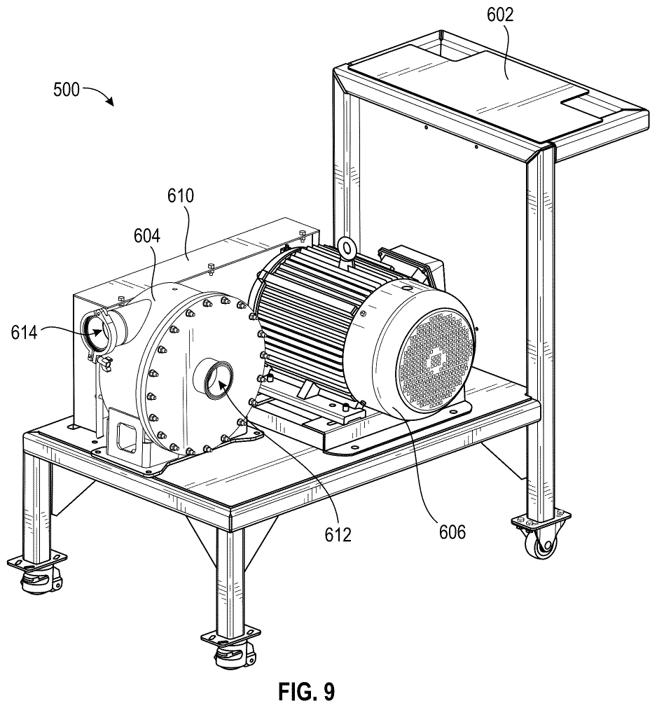

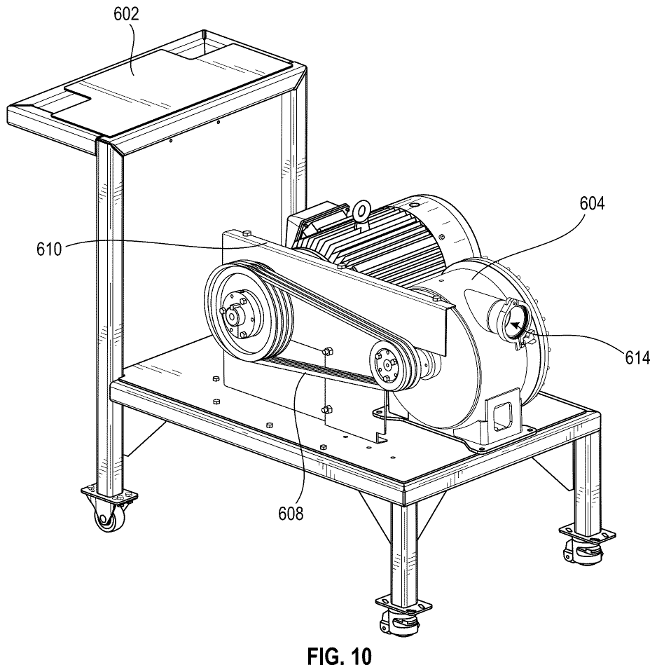

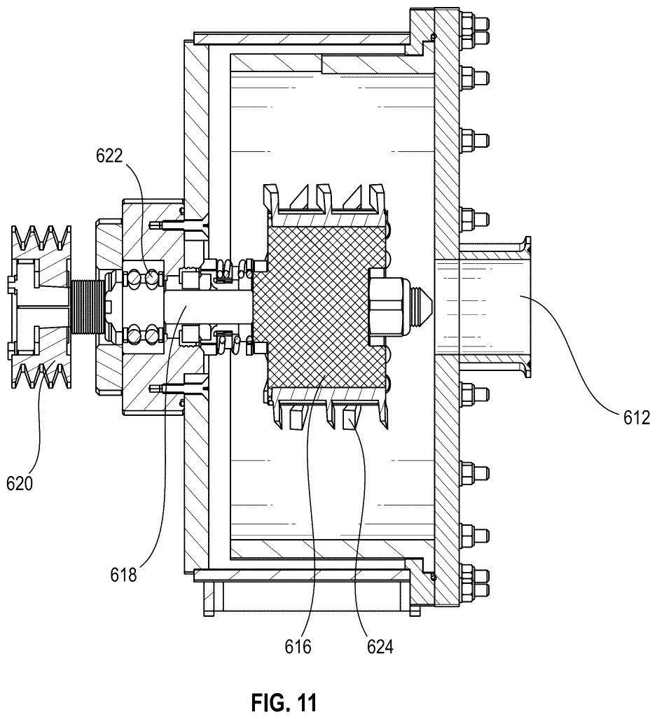

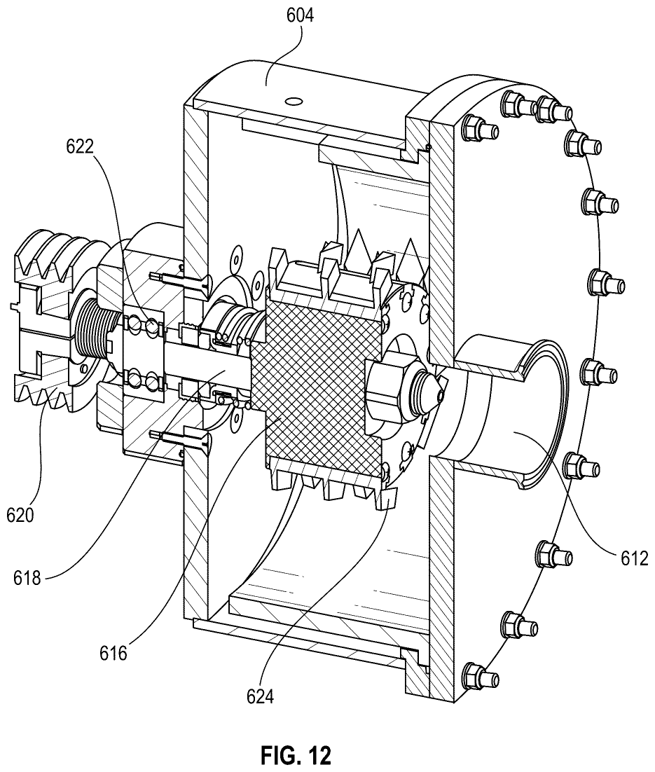

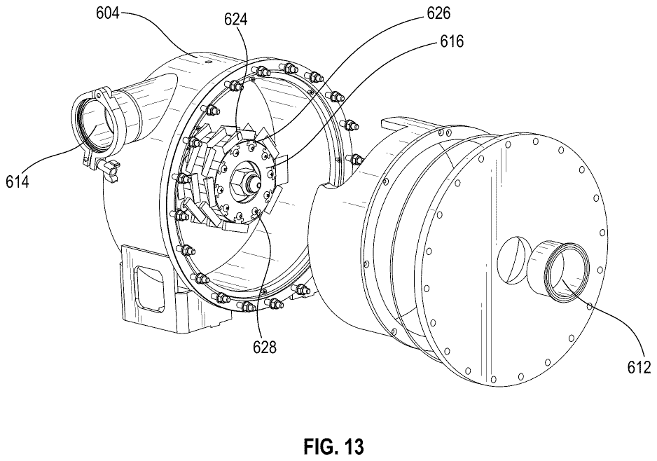

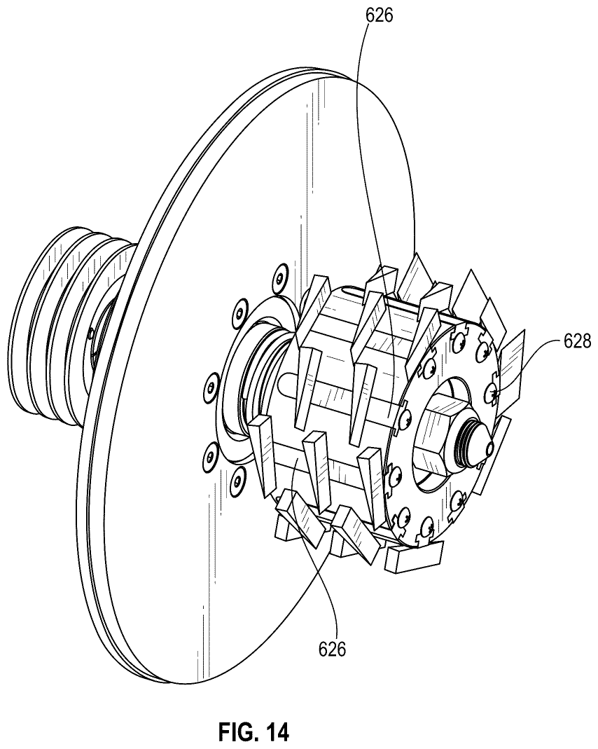

Referring now to FIGS. 9-14, a hydrodynamic cavitation system 600 is shown. The hydrodynamic cavitation system 600 may be mounted on a wheeled cart 602 and comprises a housing 604 coupled to a motor 606 via one or more belts 608 within a belt housing 610. The housing comprises an inlet 612 and an outlet 614. The housing is configured to house a rotor 616 which is driven by a driveshaft 618, which is driven by the one or more belts 608 coupled to the motor 606 via a pulley system 620. The driveshaft 618 may comprise a bearings 622, similar to the prior embodiment. As shown, the rotor 616 may by cylindrical in shape (or conical, as shown in FIG. 4) and may comprise a plurality of blades 624 on its outer circumference. The blades 624 may be arranged on blade inserts 626 (FIG. 14) that mate with respective channels along the outer circumference of the rotor 616. Each blade insert 626 may be held in position using a fastener 628, such as a screw or bolt. As shown, the position and number of blades 624 on the blade inserts 626 may vary. This allows a user to arrange the blades 624 in the manner most effective for their desired use. Additionally, the blades 624 may then be changed over time due to wear, or may also be changed to alter configurations.

As the motor 606 drives the belts 608 and the belts 608 drive the driveshaft 618, via the pulley system 620, the rotor 616 spins, causing the blades 624 to collide with incoming liquid through the inlet 612. Due the configuration and position of the blades 624, cavitation occurs (as described earlier herein), thereby breaking PFAS and other harmful substances before the liquid is expelled through the outlet 614. While belts 608 were used as an example, it will be appreciated that other common components may be used, such as chains or direct drives mechanisms, without departing herefrom.

Accordingly, the hydrodynamic cavitation systems 500, 600 disclosed herein solve the need for a system that is capable of removing PFAS and/or other forever chemicals, among other substances, from water or other liquids, overcoming the limitations of the prior art.

It will be appreciated that systems and methods according to certain embodiments of the present disclosure may include, incorporate, or otherwise comprise properties or features (e.g., components, members, elements, parts, and/or portions) described in other embodiments.

Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment unless so stated. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

Exemplary embodiments are described above. No element, act, or instruction used in this description should be construed as important, necessary, critical, or essential unless explicitly described as such. Although only a few of the exemplary embodiments have been described in detail herein, those skilled in the art will readily appreciate that many modifications are possible in these exemplary embodiments without materially departing from the novel teachings and advantages herein. Accordingly, all such modifications are intended to be included within the scope of this invention.

What is claimed is:

1. A hydrodynamic cavitation system, comprising:
a housing, comprising:
a fluid inlet,
a fluid outlet,
a plurality of dimples on a front inner surface, and
a plurality of dimples on a rear inner surface;
a rotor positioned within the housing, the rotor comprising a plurality of dimples on a front face and a plurality of dimples on a rear face, the rotor positioned so that the plurality of dimples on the front face at least partially overlap with the plurality of dimples on the front inner surface of the housing, and the plurality of dimples on the rear face at least partially overlap with the plurality of dimples on the rear inner surface of the housing;
a driveshaft coupled to the rotor and configured to rotate the rotor within the housing;
wherein as the rotor rotates, a plurality of first cavitation sites are formed via the partially overlapping dimples of the front face and the front inner surface, and a plurality of second cavitation sites are formed via the partially overlapping dimples of the rear face and rear inner surface.

2. The hydrodynamic cavitation system of claim 1, wherein the housing is an assembly formed from a front cover, a rear cover, and a center cover.

3. The hydrodynamic cavitation system of claim 2, wherein the plurality of dimples on the front inner surface are positioned on a first dimple insert.

4. The hydrodynamic cavitation system of claim 3, wherein the plurality of dimples on the rear inner surface are positioned on a second dimple insert.

5. The hydrodynamic cavitation system of claim 1, wherein the plurality of dimples on the front face of the rotor are arranged in a plurality of rows.

6. The hydrodynamic cavitation system of claim 5, wherein the plurality of dimples on the rear face of the rotor are arranged in a plurality of rows.

7. The hydrodynamic cavitation system of claim 1, further comprising a bearing housing coupled to the driveshaft, the bearing housing having one or more bearing assemblies therein.

8. The hydrodynamic cavitation system of claim 7, wherein the one or more bearing assemblies each comprise a bearing preload ring that circumscribes the driveshaft.

9. The hydrodynamic cavitation system of claim 1, wherein the housing comprises a pressure release valve.

10. The hydrodynamic cavitation system of claim 1, wherein each dimple of the housing and each dimple of the rotor comprises an edge having an attack angle between 0 to 89 degrees, which induces supercavitation and protects the rotor and the housing from erosion.

11. A hydrodynamic cavitation system, comprising:
a housing formed via a front cover, a center cover, and a rear cover coupled together with the center cover interposed between the front cover and rear cover;
the front cover comprising a fluid inlet and the rear cover comprising a fluid outlet;
the front cover further comprising a first dimple insert;
the rear cover further comprising a second dimple insert;
a rotor positioned within the housing, the rotor comprising a plurality of dimples on a front face and a plurality of dimples on a rear face, the rotor positioned so that the plurality of dimples on the front face at least partially overlap with the first dimple insert, and the plurality of dimples on the rear face at least partially overlap with the second dimple insert;
a driveshaft coupled to the rotor and configured to rotate the rotor within the center cover of the housing;
wherein as the rotor rotates, a plurality of first cavitation sites are formed via the partially overlapping dimples of the front face and the first dimple insert, and a plurality of second cavitation sites are formed via the partially overlapping dimples of the rear face and second dimple insert.

12. The hydrodynamic cavitation system of claim 11, wherein the plurality of dimples on the front face of the rotor are arranged in a plurality of rows.

13. The hydrodynamic cavitation system of claim 12, wherein the plurality of dimples on the rear face of the rotor are arranged in a plurality of rows.

14. The hydrodynamic cavitation system of claim 11, further comprising a bearing housing coupled to the driveshaft, the bearing housing having one or more bearing assemblies therein.

15. The hydrodynamic cavitation system of claim 14, wherein the one or more bearing assemblies each comprise a bearing preload ring that circumscribes the driveshaft.

16. The hydrodynamic cavitation system of claim 11, wherein the housing comprises a pressure release valve.

17. The hydrodynamic cavitation system of claim 11, wherein each dimple of the rotor comprises an edge having an attack angle between 0 to 89 degrees, which induces supercavitation that protects the rotor and housing from erosion.

18. A method of performing hydrodynamic cavitation using a hydrodynamic cavitation system, the method comprising:
feeding a contaminated liquid into the hydrodynamic cavitation system, the hydrodynamic cavitation system comprising a plurality of cavitation sites formed between a rotor comprising dimples on a face and at least one stator;
actuating the rotor of the hydrodynamic cavitation system, wherein the contaminated liquid passes through the plurality of cavitation sites to decontaminate the contaminated liquid; and
dispensing of the decontaminated liquid through an outlet of the hydrodynamic cavitation system.

19. The method of claim 18, further comprising adding an acidic radical to the contaminated liquid to synergistically help irreversibly break PFAS chemicals in the contaminated liquid.

20. The method of claim 19, wherein the acidic radical is selected from a group consisting of sodium persulfate, potassium persulfate, and peracetic acid.
